(19) United States
(12) Patent Application Publication
(10) Pub. No.: US 2014/0067144 A1
(43) Pub. Date: Mar. 6, 2014

(54) SMART SWITCH AND SMART HOME SYSTEM USING THE SAME

(71) Applicants: HON HAI PRECISION INDUSTRY CO., LTD., New Taipei (TW); HONG FU JIN PRECISION INDUSTRY (ShenZhen) CO.,LTD., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO.,LTD., Shenzhen (CN)

(21) Appl. No.: 14/013,045

(22) Filed: Aug. 29, 2013

(30) Foreign Application Priority Data
Aug. 31, 2012 (CN) 2012103178596

(51) Int. Cl. G05B 15/02

(52) U.S. Cl. CPC G05B 15/02
USPC 700/291

(57) ABSTRACT

A smart switch applied to a smart home system is connected to a power supply and at least one electronic device. The smart switch includes a storage, a power detecting unit configured to detect real-time power consumption of the electronic device connected to the smart switch and a processor unit. A table including identification code of the electronic device, a pre-determined power value relating to each electronic device and the relationship therebetween is stored in the storage. The processor unit includes a determining module configured to determine whether the real-time power of an electronic device is lower than a corresponding pre-determined power value, and a control module configured to cut off the power supply of the electronic device when the determining module determines that the real-time power of the electronic device is lower than the pre-determined power value. A smart home system is also provided.

### BACKGROUND

1. Technical Field

The present disclosure relates to smart home technology, and particularly to a smart switch and a smart home system employing the smart switch.

2. Description of Related Art

A manual switch may be arranged on a wall or floor of the house for turning on/off the power of electronic devices. Some switches also include sockets and indicator lights configured to indicate power states. However, this function of the switch is the only function, and common switches can obtain and calculate electricity consumption and other parameters.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view showing a smart home system, according to a first exemplary embodiment.

FIG. 2 is a block diagram of the smart home system of the FIG. 1.

FIG. 3 is a schematic view showing a smart home system, according to a second exemplary embodiment.

FIG. 4 is a schematic view showing a smart home system, according to a third exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

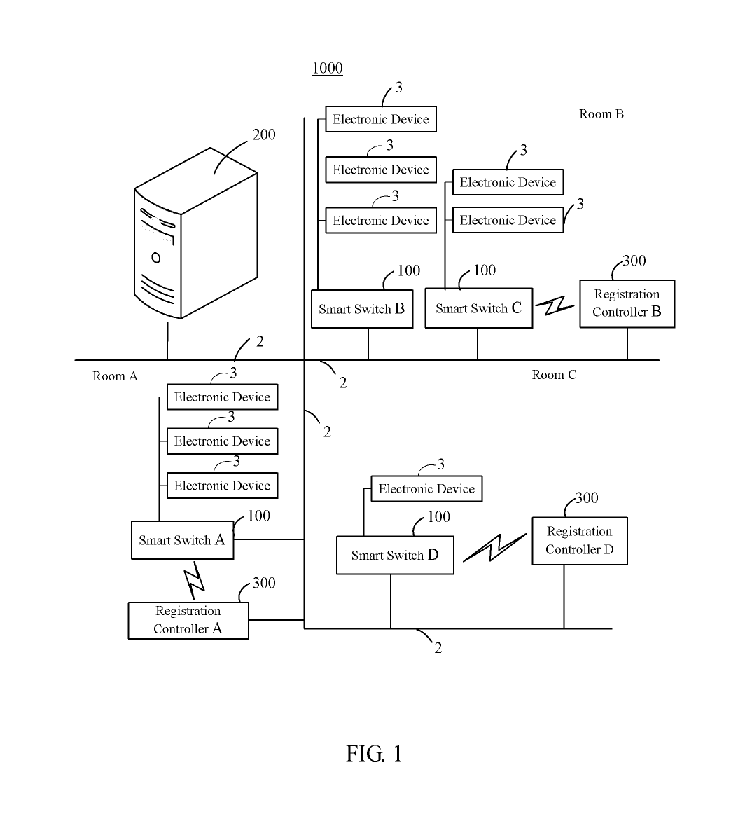

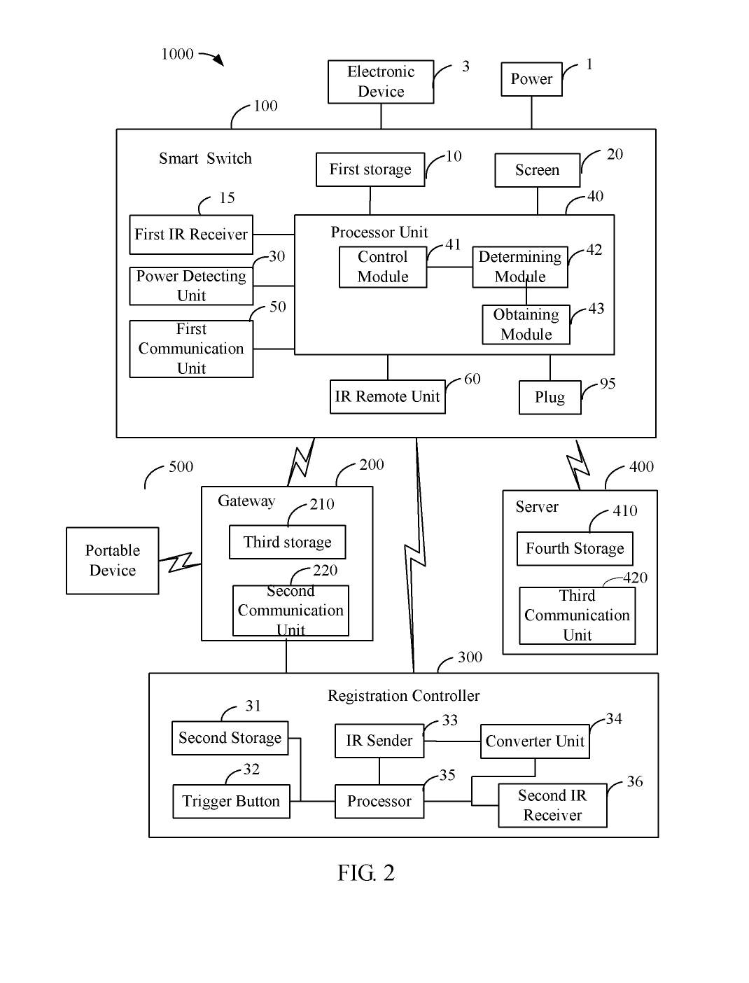

Referring to FIGS. 1 and 2, a smart home system 1000 in accordance with a first embodiment is provided. FIG. 2 is a block diagram of the smart home system 1000. The smart home system 1000 includes a plurality of smart switches 100, a gateway 200 connected to the smart switches 100 in a wired or wireless manner, such as power line 2 (or optical fiber power line), a plurality of registration controllers 300 connected to the gateway 200 in a wired or wireless manner, a number of electronic devices 3 plugged into the switches 100, a server 400 connected to the gateway 200 and a portable device 500 communicating with the server 400 and the gateway 200. The electronic devices 3 can be home appliances. The registration controllers 300 are arranged in every room of a house employing the smart home system 100. The smart switch 100 is connected to the gateway 200 in a wired or wireless manner, the wired mode can be Power Line Communication (hereinafter PLC), Optical Fiber Power Line Communication (hereinafter OPLC), wired internet communication, coaxial cable communication, telephone line communication, or other communication technologies.

Referring to FIGS. 1 and 2 again, the smart switch 100 includes a first storage 10, a screen 20, a power detecting unit 30 and a processor unit 40. The first storage 10, the screen 20 and the power detecting unit 30 are connected to the processor unit 40.

The smart switch 100 further includes a first infrared (IR) receiver 15 configured to receive IR signals sent by the registration controller 300. User can use the registration controller 300 to control the smart switches 100 in a room in which the registration controller 300 is located, to automatically register on the gateway 200. In detail, the smart switches 100 send a unique identification code (UID) to the gateway 200, to register on the gateway 200. In the first embodiment, the smart switch 100 includes a number of sockets, each of the sockets is assigned with an UID, the smart switches 100 further sends the UIDs of the sockets to the gateway 200, thereby the sockets being registered on the gateway 200. Each of the registration controllers 300 also includes a UID stored therein.

A registration process of how the smart switches 100 register on the gateway 200 is explained.

Referring to FIG. 1, the gateway 200, the smart switches 100 and the registration controllers 300 are connected to the power line 2 (or optical fiber power line), and capable of communicating with each other via PLC (or OPLC). In this embodiment, the smart switches 100 include a smart switch A 100, a smart switch B 100, a smart switch C 100 and a smart switch D 100. The registration controllers 300 include a registration controller A 300, a registration controller B 300 and a registration controller D 300. The smart switch A 100 and the registration controller A 300 are located in a room A, the smart switch B 100, the smart switch C 100 and the registration controller B 300 are located in a room B, the smart switch D 100 and the registration controller D 300 are located in a room C. The gateway 200 can automatically communicate with all devices connected on the power line 2 (or optical fiber power line) via PLC (or OPLC).

Referring to FIG. 2, each registration controller 300 includes a second storage 31, a trigger button 32, an IR sender 33, a converter unit 34, a processor 35 and a second IR receiver 36. The registration controller 300 needs to be connected to the gateway 200, before the smart switches 100 can be registered on the gateway 200. To connect the registration controller 300, the registration controller 300 is located within the communicating range of the gateway 200, and a connection program is run on the smart gateway 20. Then, the smart gateway 200 establishes communication with the registration controller 300, and sends its UID and a secret code to the registration controller 300 wirelessly. The registration controller 300 receives and saves the UID of the gateway 200 and the secret code into the second storage 31. The registration controller 300 further sends its UID to the gateway 200 wirelessly, the gateway 200 receives and saves the UID of the registration controller 300, to finish the connecting process. In this embodiment, the registration controller 300 receives the UID of the gateway 200 and the secret code via the second IR receiver 36, and sends the UID of the registration controller 300 to the gateway 200 via the IR sender 33. In this embodiment, the secret code is the UID of the gateway 200 or input by the user. The secret code is configured to encode or decode the data transmitted between the gateway 200 and the registration controller 300, thus preventing unauthorized user access. In other embodiments, the gateway 200 and the registration controller 300 can communicate via BLUETOOTH, Z-WAVE NFC, ZIGBEE, WIFI, or other communication technologies.

If user wants to register the smart switches 100 on the gateway 200, user must locate the connected registration controller 300 in the room which has the smart switches 100 needing to be registered, and run a registering program on the smart gateway 200.

For example, the registration controller B 300 shown in FIG. 1 is located in the room B, the smart switches B and C 100 are also located in the room B. The trigger button 32 generates a trigger signal in response to a pressing by user, and sends the trigger signal to the processor 35. The processor 35 controls the IR sender 33 to send a registration request to the gateway 200, and sends an IR signal in response to the trigger signal. The smart switches 100 arranged in the room B can receive the IR signal. In this embodiment, the registration controller B 300 sends the registration request to the gateway 200 via the power line 2 in response to the trigger signal. The IR signal includes the UID of the registration controller B 300, the UID of the gateway 200 and the secret code sent by the gateway 200. The smart switches B and C 100 store the UID of the registration controller B 300 and the secret code contained in the IR signal into the first storage 10. The registration request includes the UID of the registration controller B 300 and UID of the gateway 200.

The gateway 200 broadcasts signal to all of the smart switches 100 connected on the power line for determining whether the smart switch 100 has received the IR signal sent by the registration controller 300, in response to the received registration request. The smart switches 100 which receive the IR signal send an encoded registration code to the gateway 200, in response to the broadcast signal. In this embodiment, the smart switches 100 are registered on the gateway 200 in a driven registration manner.

In this example, the smart switches B and C 100 located in room B send an encoded registration code to the gateway 200, in response to the broadcast signal. The smart switches B and C 100 can send the encoded registration code to the gateway 200 via the power line. The registration code includes the UID of the smart switch 100 and the UID of the registration controller 300 stored in the first storage 10. If the smart switch 100 includes more than one socket, the registration code further includes the UID of each socket.

The gateway 200 decodes the registration code and determines whether or not the UID of the registration controller 300 contained in the registration code matches the UID of the registration controller 300 contained in the registration request; if yes, the gateway 200 stores the UID of the smart switch 100. In this way, the smart switch 100 is registered on the gateway 200, the gateway 200 can send control signals including the UID of the target smart switch 100, and all the smart switches 100 determine whether the UID of the received control signal matches with their own UID, only the matching smart switch 100 can parse the control signals, thus creating a point-to-point communication between the gateway 200 and the smart switch 100.

In an embodiment, the converter unit 34 of the registration controller 300 is configured to receive the control signals from the power line 2 sent by the gateway 200 and convert the control signals. The IR sender 33 sends the converted control signals to the corresponding smart switch 100 to control the electronic device 3 connected on the smart switch 100.

In an embodiment, the smart switch 100 which receives the IR signal sends an encoded registration code to the gateway 200 directly. In this way, the smart switches 100 can be registered on the gateway 200 in a forward registration manner, instead of the driven registration manner mentioned before. The other registration processes in the forward registration manner are the same as those of the driven registration manner, they are not repeated here.

All the signals transmitted between the smart switches 100, the gateway 200 and the registration controller 300 via the power line 2 mentioned in disclosure, include the UID of the device which sends the signals and the UID of the device which receives the signals. Furthermore, a secret code is used to encode the signals transmitted between the smart switches 100, the gateway 200 and the registration controller 300 via the power line 2, and the secret code is stored in smart switches 100, the gateway 200 and the registration controller 300.

In an embodiment, the registration controller 300 has the same appearance and function as the smart switch 100, the difference between the registration controller 300 and the smart switch 100 is that the registration controller 300 further includes a trigger button 32 and an IR sender 33. The registration controller 300 not only serves to control the smart switches 100 to automatically register on the gateway 200, but also acts as a smart switch.

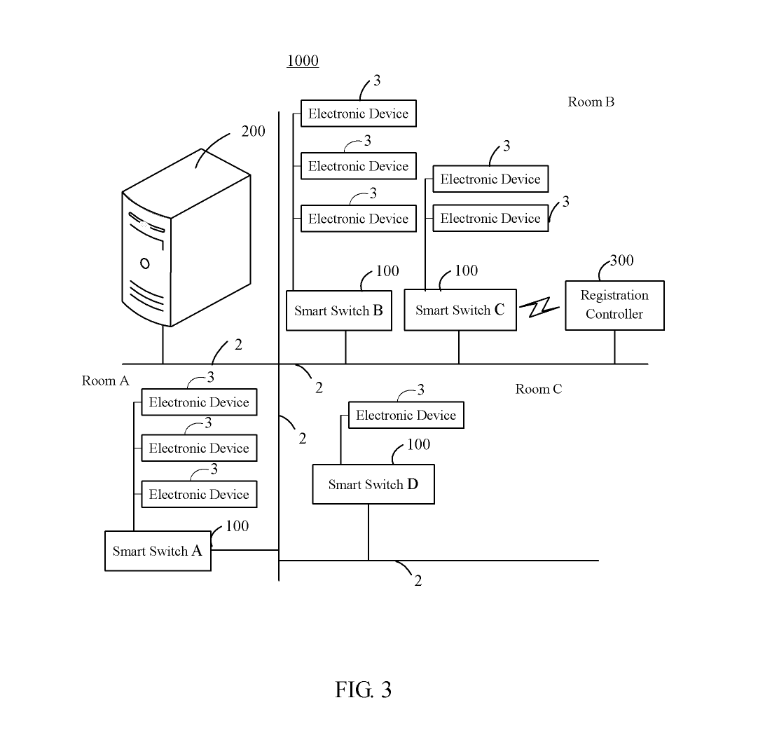

Referring to FIG. 3, in a second embodiment, only one registration controller 300 is employed in the smart home system 1000.

The registration controller 300 is connected to the gateway 200, before the smart switches 100 register on the gateway 200, and the connection process is the same as mentioned in the first embodiment.

If user wants to register the smart switches 100 on the gateway 200, user should locate the connected registration controller 300 in the room which has the smart switches 100 needing to be registered, and run a registering program on the gateway 200.

For example, the registration controller 300 shown in FIG. 3 is located in the room B, the smart switches B and C 100 are also located in the room B. The trigger button 32 generates a trigger signal in response of user pressing it, and sends the trigger signal to the processor 35. The processor 35 controls the registration controller 300 to send a registration request to the gateway 200. In this embodiment, the registration controller 300 sends the registration request to the gateway 200 via the power line 2 in response to the trigger signal. The gateway 200 generates a serial code and sends the serial code to the registration controller 300 in response to the registration request. In this embodiment, the gateway 200 sends the serial code to the registration controller 300 via the power line 2. The serial codes generated by the gateway 200 responding of the registration request are different each time, in this embodiment, the serial codes are generated according to the time of the received registration request. For example, when the gateway 200 receives the registration request a first time, the gateway 200 generates a first serial code, such as 01; when the gateway 200 receives the registration request for the second time, the gateway 200 generates a second serial code, such as 02.

The processor 35 of the registration controller 300 controls the IR sender 33 to send an IR signal in response to the received serial code, the IR signal includes the serial code, the UID of the registration controller 300, the UID of the gateway 200 and the secret code sent by the gateway 200. The smart switches B and C 100 can receive the IR signal. The smart switches B and C 100 store the serial code, the UID of the registration controller 300, and the secret code contained in the IR signal, into the first storage 10.

The gateway 200 further broadcasts signal to all of the smart switches 100 connected on the power line for determining whether the smart switch 100 has received the IR signal sent by the registration controller 300. The smart switches 100 which receive the IR signal send an encoded registration code to the gateway 200 via the power line 2, in response to the broadcast signal. In this embodiment, the smart switches 100 are registered on the gateway 200 in a driven registration manner.

In this embodiment, the smart switches B and C 100 arranged in room B send the encoded registration code to the gateway 200 in response to the broadcast signal. The registration code includes the serial code, the UID of the smart switch 100 and the UID of the registration controller 300 stored in the first storage 10. If the smart switch 100 includes more than one socket, the registration code further includes the UID of the each socket.

The gateway 200 decodes the registration code and determines whether the UID of the registration controller 300 contained in the registration code matches the UID of the registration controller 300 contained in the registration request; if yes, the gateway 200 stores the UID of the registration code. In this way, the smart switch 100 is registered on the gateway 200, the gateway 200 can send control signals including the UID of the target smart switch 100, and the smart switch 100 determines whether the UID of the received control signal matches with its own UID, only the matching smart switch 100 can parse the control signals, thus creating a point-to-point communication between the gateway 200 and the smart switch 100.

Also, the smart switches 100 can be registered on the gateway 200 in a forward registration manner, the smart switch 100 which receives the IR signal sends an encoded registration code to the gateway 200 directly, and the other registration processes in the forward registration manner are the same as those of the driven registration manner, they are not repeated here.

The first embodiment and the second embodiment illustrate the connecting registration process of the registration controller 300 in connecting to the gateway 200 and the registration process of the smart switches 100 registering on the gateway 200. After registering the smart switches 100 on the gateway 200, the gateway 200 is capable of sending a controlling signal to the smart switches 100, to control the electronic devices 3 connected to the smart switch 100.

In the first embodiment, the portable device 500 can be a smart phone, tablet PC, notebook or other portable electronic device. Each of the electronic devices 3 has a related and pre-determined power value, the pre-determined power value is the instantaneous power consumption of the related electronic device 3 in a standby state. When such power consumption of the related electronic device 3 is lower than the pre-determined power value, the electronic device 3 is on a standby state or powered off, and in this situation, the power of the electronic device 3 should be cut off for energy saving. In this embodiment, the UIDs of the electronic devices 3, the pre-determined power value relating to each of the electronic devices 3 and the relationships therebetween are stored in the smart switch 100, the gateway 200 or the server 400.

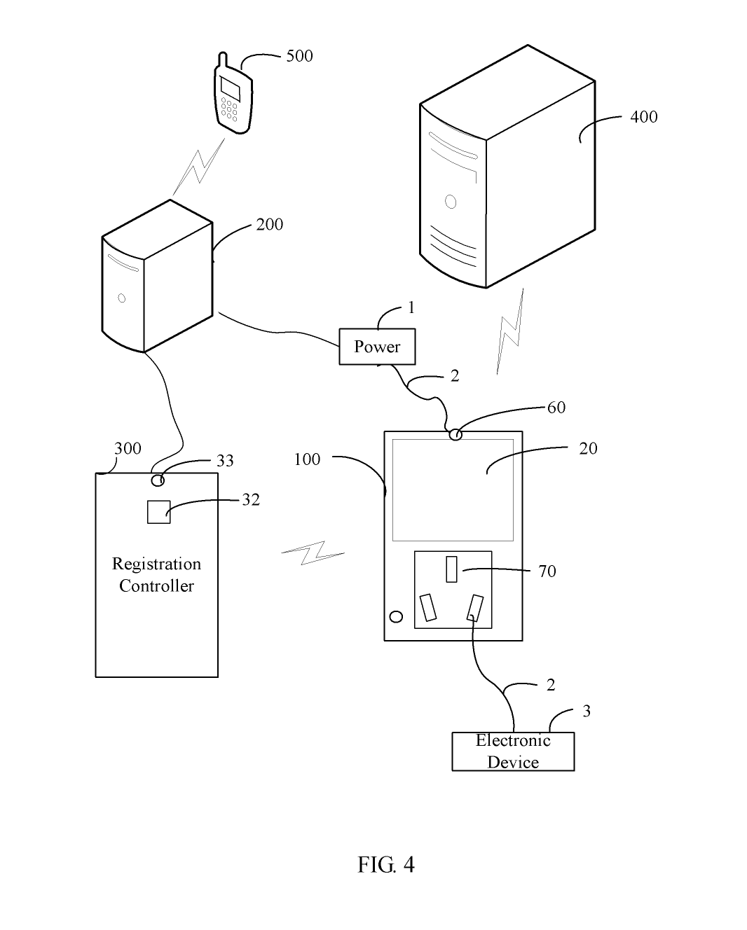

The smart switch 100 includes at least one socket 70 configured to be connected to the plug of the electronic device 3. The smart switch 100 also can be a button switch or a rocker switch, without socket. As shown in FIG. 4, the smart switch 100 includes one three-phase socket 70 configured to connect to a three-phase plug of the electronic device 3. In other embodiments, the socket 70 can be a two-phase socket, and the smart switch 100 can include two or more sockets 70. In an embodiment, the smart switch 100 includes one or more indicator lights, each of the indicator light is related to one socket 70 of the smart switch 100 and configured to indicate the power state of the electronic device 3 connected to the related socket 70. The electronic devices 3 can be fridges, air-conditioners, computers, fans, TVs, lamps, micro wave ovens, and the like.

The smart switch 100 is capable of automatically detecting real-time electricity information of the electronic devices 3 connected on the smart switch 100, such as the voltage, current or power of the electronic devices 3. When the real-time power consumption of the related electronic device 3 is lower than the pre-determined power value, the smart switch 100 cuts off the power supply to the electronic device 3 automatically. The smart switch 100 further determines a proposed operation according the real-time electricity information of the electronic devices 3 and sends the proposed operation to the portable device 500 via the gateway 200. The smart switch 100 also receives commands sent by the portable device 500 via the gateway 200, and cuts off the power supply to the connected electronic device 3 according to the commands.

The smart switch 100 includes a first storage 10, a screen 20, a power detecting unit 30, a processor unit 40, a first communication unit 50 and an IR remote unit 60. A table including the UIDs of the electronic devices 3, the pre-determined power values relating to each of the electronic devices 3 and the relationships therebetween is stored in the first storage 10. The screen 20 is configured to display the real-time electricity information of the electronic devices 3 connected to the smart switch 100. In another embodiment, the smart switch 100 does not have a screen. The power detecting unit 30 is configured to detect real-time electricity information of the electronic devices 3 connected to the smart switch 100, such as the voltage, current or power of the electronic devices 3. The real-time electricity consumption of the electronic device 3 is equal to the product of the voltage and the current thereof. The power detecting unit 30 further sends the real-time electricity information and the UID of the related electronic device 3 to the processor unit 40. The screen 20 can be an LCD, an electronic paper display, an LED display, or a touch display. The first communication unit 50 is configured to establish communication to the gateway 200 and the server 400. In this embodiment, the gateway 200 includes a second communication unit 220, and the server 400 includes a third communication unit 420.

The processor unit 40 includes a control module 41 and a determining module 42. The control module 41 controls the screen 20 to display the real-time electricity information of the electronic devices 3 connected to the smart switch 100. The determining module 42 determines whether the real-time power of the electronic device 3 is lower than a pre-determined power value according to the real-time electricity information and the UID of the related electronic device 3 sent by the power detecting unit 30 and the relationships between the UID of the electronic device 3 and the pre-determined power values stored in the table. If so, the control module 41 sends a request signal to the portable device 500 via the first communication unit 50.

The portable device 500 displays a notification to user to select whether to turn off the electronic device 3 or not, in response to the request signal. The portable device 500 sends a confirm order to the smart switch 100 if user selects turning off the electronic device 3; and sends a cancel order to the smart switch 100 if user selects not to turn off the electronic device 3. The first communication unit 50 of the smart switch 100 receives the confirm order and the cancel order.

The control module 41 controls the IR remote unit 60 to send a shutdown signal to the related electronic device 3 in response to the confirm order, the electronic device 3 can receive the shutdown signal and shutdown automatically. The smart switch 100 maintains the power supply to the related electronic device 3 in response to the cancel order.

The control module 41 further cuts off the power supply to an electronic device 3, such as by cutting off the connection between the socket 70 and the plug of the related electronic device 3 by using a relay or other electronic switch. For example, when a TV is shutdown, some of the TV elements, such as the indicator, are still working, therefore the control module 41 cuts off the power supply to the TV to save energy. In this embodiment, if the smart switch 100 does not receive any commands sent by the portable device 500 within a predetermined time period, the control module 41 further cuts off the power supply of the electronic device 3.

In an alternative embodiment, the smart switch 100 does not send the request signal to the portable device 500, when the determining module 42 determines that the real-time power of an electronic device 3 is lower than a pre-determined power value, the control module 41 simply controls the IR remote unit 60 to send a shutdown signal to the electronic device 3 and cuts off the power supply, such as by cutting off the connection between the socket 70 and the plug of the related electronic device 3.

In an embodiment, the table including the UIDs of the electronic devices 3, the pre-determined power values relating to each of the electronic devices 3 and the relationships therebetween is not stored in the first storage 10, the table is stored in a third storage 210 of the gateway 200 and/or a fourth storage 410 of the server 400. The smart switch 100 includes an obtaining module 43 configured to obtain the pre-determined power value of the related electronic device 3 according to the UID of the electronic device 3 sent by the power detecting unit 30, and the relationships between the UID of the electronic device 3 and the pre-determined power values stored in the table. The determining module 42 determines whether the real-time power of the electronic device 3 is lower than a pre-determined power value obtained by the obtaining module 43. The other controlling processes in this embodiment are similar to those of the disclosure mentioned before, and are not repeated here.

In an embodiment, the smart switch 100 further includes a plug 95 configured to connect the smart switch 100 to the power 1, thus connecting the power 1 and the electronic devices 3.

When two or more electronic devices 3 are connected to the smart switch 100 via the sockets 70, the power detecting unit 30 can detect the real-time electricity information of the electronic devices 3 and send the real-time electricity information and the UID of the related electronic device 3 to the processor unit 40. The control module 41 controls the screen 20 to display the real-time electricity information of the electronic device 3. The determining module 42 determines whether the real-time power of each electronic device 3 is lower than a corresponding pre-determined power value. Users can obtain the real-time electricity information, the total electricity consumption and the energy charge of the electronic device 3 from the screen 20. When the real-time power of the related electronic device 3 is lower than a pre-determined power value, the smart switch 100 cuts off the power supply of the electronic device 3 automatically, such as shutting down the electronic device 3 or cutting off the connection between the socket 70 and the plug of the related electronic device 3, by using a relay or other electronic switch. The smart switch is 100 further capable of sending a request signal to the portable device 500 to ask user to select either turning off or not turning off the electronic device 3.

Referring to FIG. 4, the smart switch 100 is connected to at least one electronic device 3 and a power 1. The smart switch 100 is capable of automatically detecting power state of the connected electronic device 3, and displaying electricity consumption and energy charge of the connected electronic device 3 to users. The smart switch 100 can be a switch including a display, or including a display and one or more sockets.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart switch to be applied to a smart home system, the smart switch connecting to a power and at least one electronic device, the smart switch comprising:
a storage configured to store a table comprising an identification code of the electronic device, a pre-determined power value relating to each of the electronic device and the relationship therebetween;
a power detecting unit configured to detect real-time power consumption of the electronic device connected on the smart switch; and
a processor unit connected to the power detecting unit, comprising a determining module configured to determine whether the real-time power of the electronic device is lower than the corresponding pre-determined power value according to the identification code of the electronic device sent by the electronic device and the table stored in the storage, and a control module configured to cut off the power supply of the related electronic device connected on the smart switch when the determining module determine that the real-time power of the electronic device is lower than the corresponding pre-determined power value.

2. The smart switch as described in claim 1, further comprising an Infrared remote unit, wherein the control module controls the Infrared remote unit to send a shutdown signal to the related electronic device when the determining module determine that the real-time power of the electronic device is lower than the corresponding pre-determined power value.

3. The smart switch as described in claim 1, further comprising a socket configured to connect a plug of the electronic device, wherein the socket is a three-phase socket or a two-phase socket.

4. The smart switch as described in claim 1, further comprising a plug configured to connect the smart switch to the power.

5. A smart switch applied to a smart home system, the smart switch connecting to a power and at least one electronic device, the smart switch communicating with the electronic device via Power Line Communication (PLC) or Optical Fiber Power Line Communication (OPLC), the smart switch comprising:
a storage configured to store a table comprising identification code of the electronic device, a pre-determined power value relating to each of the electronic device and the relationship therebetween;
a power detecting unit configured to detect real-time power consumption of the electronic device connected on the smart switch; and
a processor unit connected to the power detecting unit, comprising a determining module and a control module;
wherein the determining module determines whether the real-time power of the electronic device is lower than the corresponding pre-determined power value according to the identification code of the electronic device sent by the electronic device and the table stored in the storage; the control module sends a request signal to a portable device for asking whether to cut off the power supply of the elated electronic device connected on the smart switch when the determining module determines that the real-time power of the electronic device is lower than the corresponding pre-determined power value, and cuts off the power supply of the related electronic device in response of a confirm order sent by the portable device.

6. The smart switch as described in claim 5, further comprising an Infrared remote unit, wherein the control module controls the Infrared remote unit to send a shutdown signal to the related electronic device when the determining module determine that the real-time power of the electronic device is lower than the corresponding pre-determined power value.

7. The smart switch as described in claim 5, further comprising a socket configured to connect a plug of the electronic device, wherein the socket is a three-phase socket or a two-phase socket.

8. The smart switch as described in claim 5, further comprising a plug configured to connect the smart switch to the power.

9. A smart home system comprising at least one smart switch and a gateway communicating to the smart switch with each other via Power Line Communication (PLC) or Optical Fiber Power Line Communication (OPLC), the smart switch connecting to a power and at least one electronic device, the gateway stored a table comprising identification code of the electronic device, a pre-determined power value relating to each of the electronic device and the relationship therebetween; the smart switch comprising:
a power detecting unit configured to detect real-time power consumption of the electronic device connected on the smart switch;
a processor unit connected to the power detecting unit, comprising a determining module configured to determine whether the real-time power of the electronic device is lower than the corresponding pre-determined power value according the identification code of the electronic device sent by the electronic device and the table stored in the storage, and a control module configured to cut off the power supply of the related electronic device connected on the smart switch when the determining module determines that the real-time power of the electronic device is lower than the corresponding pre-determined power value.

10. The smart home system as described in claim 9, wherein the control module further sends a request signal to a portable device for asking whether to cut off the power supply of the elated electronic device connected on the smart switch when the determining module determine that the real-time power of the electronic device is lower than the corresponding pre-determined power value, and cuts off the power supply of the related electronic device in response of a confirm order sent by the portable device.

11. The smart home system as described in claim 10, wherein the smart switch further comprises an Infrared remote unit, the control module controls the Infrared remote unit to send a shutdown signal to the related electronic device when the determining module determines that the real-time power of the electronic device is lower than the corresponding pre-determined power value.

12. The smart home system as described in claim 9, further comprising a registration controller communicating to the gateway via wired or wireless communication mode, wherein the gateway sends an identification code of the gateway and a secret code to the registration controller when the registration controller is located within the communicating range of the smart gateway and a mating program is run on the gateway, and the registration controller further send an identification code of the registration controller to the gateway.

13. The smart home system as described in claim 12, wherein the secret code is the identification code of the gateway or input by a user.

14. The smart home system as described in claim 12, wherein the registration controller comprises:
a second Infrared receiver configured to receive the identification code of the gateway and the secret code sent by the gateway;
a trigger button configured to generate a trigger signal in response of the user's pressing;
an Infrared sender; and
a processor configured to control the Infrared sender to send an Infrared signal comprising the identification code of the registration controller and the secret code, and control the registration controller to send a registering request to the gateway;
the smart switch further comprises a first Infrared receiver configured to receive the Infrared signal and a storage configured to save the Infrared signal, the smart switch further sends a registration code encoded by the secret code to the smart gateway, the registration code comprises the identification code of the smart switch and the identification code of the registration controller;
the gateway decodes the registration code and saves the identification code of the registration controller.

15. The smart home system as described in claim 12, wherein the gateway sends a broadcasting signal to the smart switch in response of the received registration request, the smart switch which has received the Infrared signal sends the registration code to the smart gateway in response of the broadcasting signal.

16. The smart home system as described in claim 14, wherein the smart switch comprises a socket, and the registration code further comprises an identification code of the socket.

17. The smart home system as described in claim 14, wherein the smart switch comprises a storage unit configured to store a formula and an electrovalence, and the calculating module further calculates energy charge of the electronic device according to the formula stored in the first storage, the electrovalence and the total electricity consumption.

18. The smart home system as described in claim 9, wherein the smart switch comprises a plug configured to connect the smart switch to the power.
